(19) United States
(12) Patent Application Publication
(10) Pub. No.: US 2019/0085706 A1
(43) Pub. Date: Mar. 21, 2019

(54) TURBINE ENGINE AIRFOIL ASSEMBLY

(71) Applicant: General Electric Company, Schenectady, NY (US)

(72) Inventors: Zachary Daniel Webster, Mason, OH (US); Kirk D. Gallier, Cincinnati, OH (US)

(21) Appl. No.: 15/707,464

(22) Filed: Sep. 18, 2017

(51) Int. Cl. F01D 5/18; F01D 9/04

(52) U.S. Cl. CPC F01D 5/186; F01D 9/041; F05D 2240/12; F05D 2260/201; F05D 2260/202; F05D 2240/81

(57) ABSTRACT

An airfoil assembly for a turbine engine can include a platform having a fore edge, an aft edge axially spaced from the fore edge, and opposing heated and cooled surfaces. An airfoil can extend from the heated surface of the platform, and a cooling cavity can be positioned interiorly of the platform.

### BACKGROUND

Turbine engines, and particularly gas or combustion turbine engines, are rotary engines that extract energy from a flow of pressurized combusted gases passing through the engine onto a multitude of rotating turbine blades.

Turbine engines can be designed to operate at high temperatures to maximize efficiency, and suitable cooling of engine components such as nozzle assemblies can be beneficial for engine efficiency, longevity, and costs of operation.

### BRIEF DESCRIPTION

In one aspect, an airfoil assembly for a turbine engine includes a platform having a fore edge, an aft edge axially spaced from the fore edge, and opposing heated and cooled surfaces separating a hot gas flow along the heated surface from a cool gas flow along the cooled surface, an airfoil extending from the heated surface of the platform, the airfoil having a leading edge and a trailing edge and extending between a pressure side and a suction side, a cooling cavity located interiorly of the platform, a first cooling passage fluidly connecting the cooled surface to the cooling cavity and defining a first centerline, and a second cooling passage fluidly connecting the heated surface to the cooling cavity and defining a second centerline, which is unaligned with the first centerline.

In another aspect, a turbine engine comprising a fan section, compressor section, a combustion section, and a turbine section in axial flow arrangement to define an engine centerline, with at least one of the compressor section and turbine section having an airfoil assembly including radially spaced inner and outer bands having axially spaced fore and aft edges, with at least one of the inner and outer bands having opposing heated and cooled surfaces separating a hot gas flow from a cool gas flow, at least two airfoils extending between the inner and outer bands, each of the at least two airfoils having a leading edge and a trailing edge and extending between a pressure side and a suction side, a cooling cavity located interiorly of the at least one of the inner or outer bands, a first cooling passage fluidly connecting the cooled surface to the cooling cavity and defining a first centerline, and a second cooling passage fluidly connecting the heated surface to the cooling cavity and defining a second centerline, which is unaligned with the first centerline.

In yet another aspect, a method of supplying cooling air to a cavity in a cooled platform in a turbine engine includes supplying cooling air from a cooled surface of the platform along a first direction through a first passage, and emitting the cooling air to a heated surface of the platform along a second direction through a second passage, the second direction being different from the first direction.

### BRIEF DESCRIPTION OF THE DRAWINGS

In the drawings:

FIG. 1 is a schematic cross-sectional diagram of a turbine engine for an aircraft having an airfoil assembly according to various aspects described herein.

FIG. 2 is a perspective view of an airfoil assembly in the turbine engine of FIG. 1.

FIG. 3 is a perspective view of two airfoils in the airfoil assembly of FIG. 2.

FIG. 4 is a cross-sectional view of a cooling cavity in a band of the airfoil assembly of FIG. 2 along the line 4-4.

FIG. 5 illustrates an exemplary cooling cavity in the airfoil assembly of FIG. 2.

FIG. 6 illustrates an exemplary cooling cavity in the airfoil assembly of FIG. 2.

FIG. 7 illustrates an exemplary cooling cavity in the airfoil assembly of FIG. 2.

### DESCRIPTION OF EMBODIMENTS

The described embodiments of the present disclosure are directed to an airfoil assembly for a turbine engine. For purposes of illustration, the present disclosure will be described with respect to the turbine for an aircraft turbine engine. It will be understood, however, that the disclosure is not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

As used herein, “a set” can include any number of the respectively described elements, including only one element. Additionally, the terms “radial” or “radially” as used herein refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

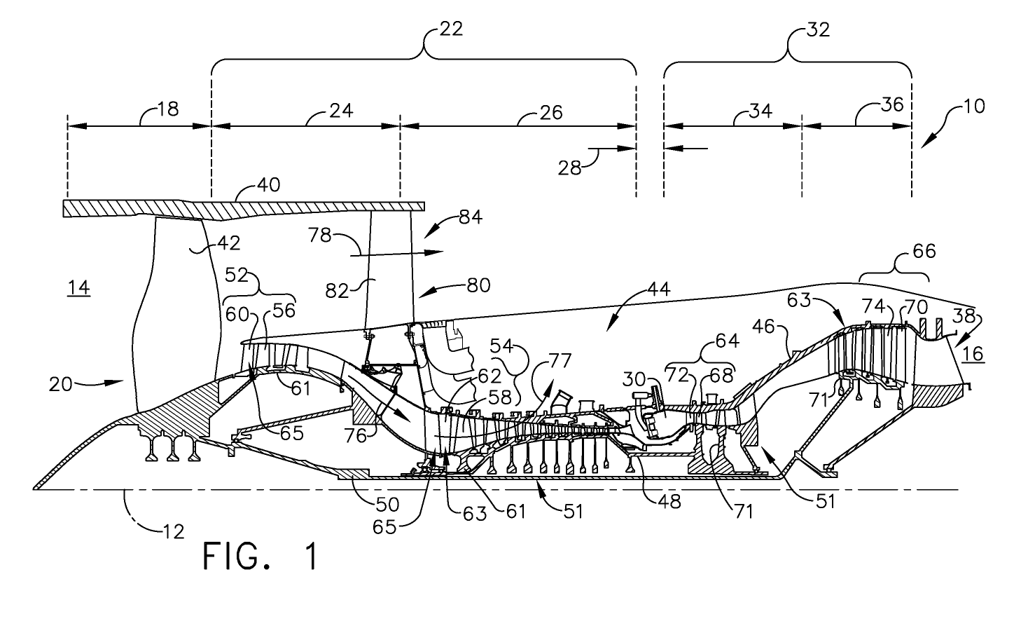

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to (or integral to) a disk 61, which is mounted to the corresponding one of the HP and LP spools 48, 50. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74, also referred to as a nozzle, to extract energy from the stream of fluid passing through the stage. In a single turbine stage 64, 66, multiple turbine blades 68, 70 can be provided in a ring and can extend radially outwardly relative to the centerline 12 while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

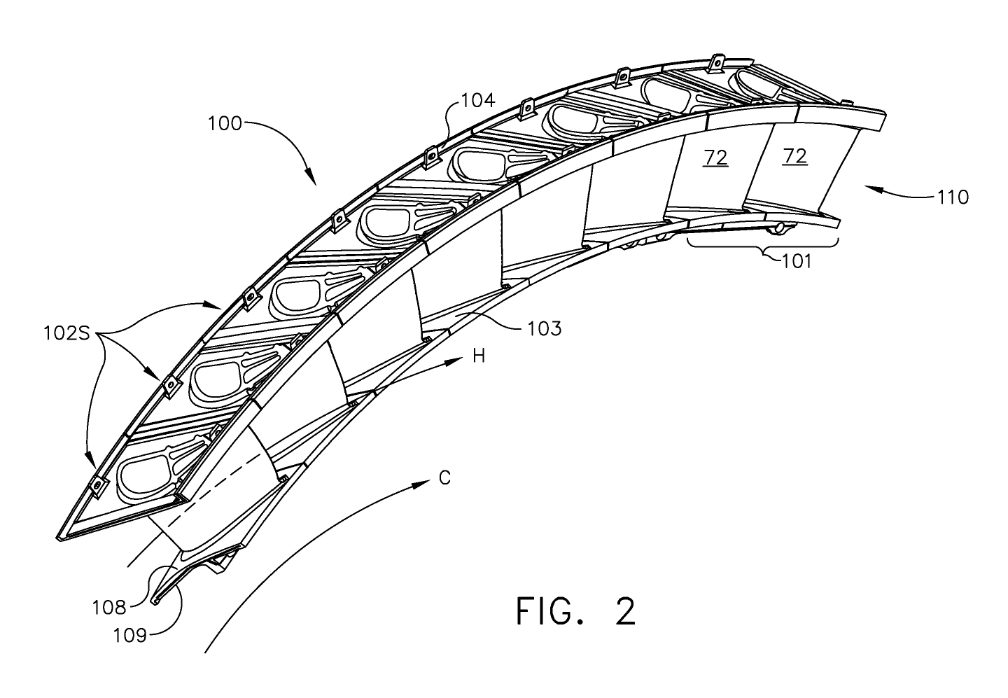

Referring to FIG. 2, an airfoil assembly 100 for the turbine section 32 can be formed as an annular set of airfoils 110 extending from a set of platform segments 1025. The airfoil assembly 100 is illustrated with vanes, such as the HP turbine vanes 72, forming a set of nozzles 101 in circumferential arrangement. It is also contemplated that the airfoil assembly can include any rotating or non-rotating airfoil within the turbine engine 10, including within the compressor section 22 or turbine section 32 (FIG. 1). The circumferential arrangement of nozzles 101 defines an annular organization for the airfoil assembly 100, which can be positioned around the engine centerline of FIG. 1. In one non-limiting example, the airfoil assembly 100 can be positioned within the first stage of the high pressure turbine 34 immediately downstream of the combustion section 28 (FIG. 1). It will be understood that the airfoil assembly 100 is contemplated for use anywhere within the turbine engine 10, including within the compressor section 22 or the turbine section 32 as desired. Alternatively, the airfoil assembly could be positioned in the secondary cooling supply system, such as in an inducer, accelerator, or turbine on-boarding inducer.

Each nozzle 101 is illustrated as including an inner band 103 and an outer band 104, where each of the inner and outer bands 103, 104 can include a fore edge 105 and an aft edge 106. It will be understood that the platform segment 102 can be defined by either of the inner band 103 or outer band 104; furthermore, either of the inner band 103 or outer band 104 can define a platform 102 which includes the set of platform segments 102S. The platform 102 can further include a flange 102F as shown.

Two static vanes 72 defining the nozzle 101 can extend between the bands 103, 104. In non-limiting examples, the nozzles 101 can be uncooled nozzles without providing internal cooling from an exterior source, or subsonic nozzles adapted to operate under flow speeds less than the speed of sound. While only four nozzles 101 are illustrated, it should be understood that a plurality of nozzles 101 can be arranged to form the annular airfoil assembly 100.

A hot gas flow H is illustrated for an airflow passing through the airfoil assembly 100, between the inner and outer bands 103, 104 and through the vanes 72. The hot gas flow H can illustrate combustion gases exiting the combustor 30 of FIG. 1 and flowing through the turbine section 32; it should be understood that the hot gas flow H can also illustrate pressurized gases upstream of the combustor 30 in an example where the airfoil assembly 100 is positioned within the compressor section 22 (FIG. 1). A cool gas flow C illustrates cooling air within the inner or outer band 103, 104 that can also be supplied to the interior of the vanes 72 to cool the airfoil assembly 100.

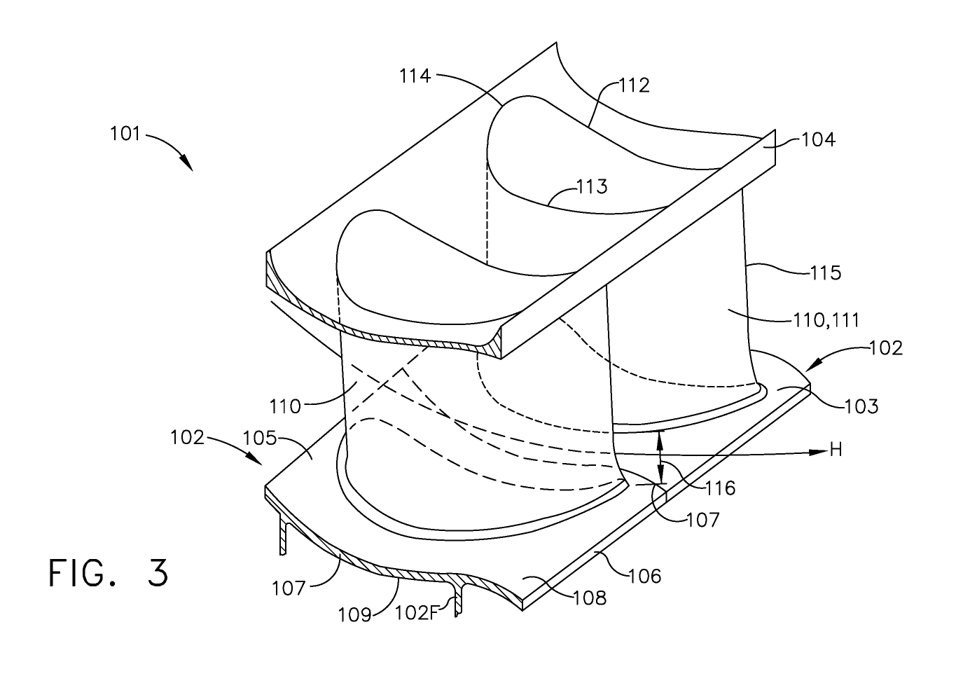

Referring to FIG. 3, an exemplary turbine nozzle 101 is shown including two segments 102S abutting at an interface 107. An airfoil 110 (such as the vane 72) can extend from each segment 102, each airfoil 110 having an outer wall 111 defining a pressure side 112 and a suction side 113 and extending between a leading edge 114 and a trailing edge 115. While the nozzle 101 is illustrated with one airfoil 110 per segment 102 in a singlet arrangement, it should be understood that any number of airfoils 110 can be provided in a segment 102. In non-limiting examples, two airfoils 110 can be included per segment 102 in a doublet arrangement, or singlets and doublets can be coupled in an alternating pattern when forming the airfoil assembly 100. It will also be understood that while described in relation to static airfoils 110 such as the vanes 72, aspects described herein can have equal applicability to rotating blades, such as the blades 68, 70 of FIG. 1.

Adjacent airfoils 110 can be circumferentially spaced from one another as shown; it is contemplated that the airfoils 110 can be equally spaced apart, or a variable spacing between airfoils 110 in the annular airfoil assembly 100 can be utilized based on the desired environment within the turbine engine 10. The shortest distance between adjacent airfoils can define a throat 116; commonly, the airfoils 110 are arranged such that the throat 116 is formed between the suction side 113 of one airfoil 110 and the trailing edge 115 of an adjacent airfoil 110 as illustrated in the example of FIG. 3. In addition, the hot gas flow H illustrates a direction of air flow through the nozzle 101 from the fore edge 105 to the aft edge 106 of the inner band 103.

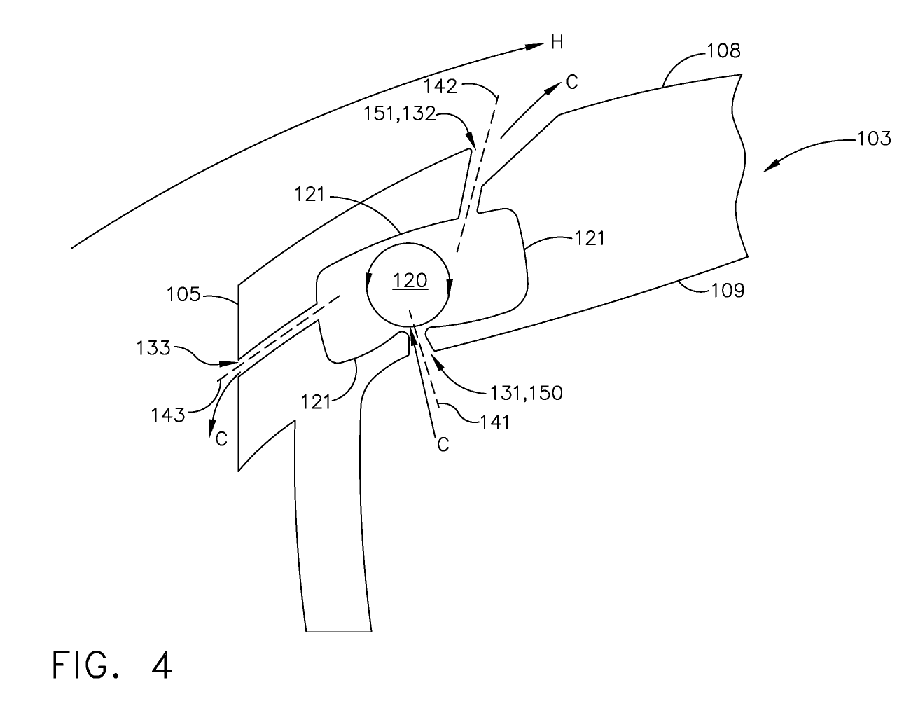

Either or both of the inner and outer bands 103, 104 can include a cooling cavity 120. Turning to FIG. 4, it is contemplated that the cooling cavity 120 can be positioned interiorly of the inner band 103; it should be understood that, while illustrated within the inner band 103, aspects described herein can also be applied to the outer band 104 or to a platform of a rotating blade such as the blades 68, 70 of FIG. 1. It can be seen that the cooling cavity 120 can include a set of inner walls 121, a first cooling passage 131 with an inlet 150 on the cooled surface 109, and a second cooling passage 132 with an outlet 151 on the heated surface 108. The first cooling passage can define a first centerline 141, and the second cooling passage 132 can define a second centerline 142 which can be unaligned with the first centerline 141. In this manner, the cooling cavity can be fluidly coupled to both the cooled surface 109 and heated surface 108.

The cooling cavity 120 can also include a third cooling passage 133 with an outlet 151 on the fore edge 105 of the inner band 103. The third cooling passage 133 can define a third centerline 143, and it is contemplated that the centerlines 141, 142, 143 can be mutually unaligned with one another. In this manner, the cooling cavity 120 can also be fluidly coupled to the fore edge 105 in addition to the heated and cooled surfaces 108, 109.

The cooling cavity 120, and any or all of the cooling passages 131, 132, 133 can be formed by additive manufacturing methods or through methods such as casting or drilling. In an example where additive manufacturing is utilized, it can be appreciated that the cooling cavity 120 or passages 131, 132, 133 can be integrally formed with the inner band 103. Furthermore, while illustrated in the context of the inner band 103, it will be understood that aspects described herein can also be applied to the outer band 104 or any platform in an airfoil assembly within the engine as desired.

In operation, cooling air such as the cool gas flow C can flow from the cooled surface 109 through the inlet 150 of the first cooling passage 131 and impinge an inner wall 121 of the cooling cavity 120. The air impingement can create turbulence or vortices within the cavity 120, providing cooling to the interior of the inner band 103, and the cooling air can exit through the second cooling passage 132 to the heated surface 108 via the outlet 151. It is contemplated that the outlet 151 can be shaped to direct the cooling air C in a direction aligned with the hot gas flow direction H to aid in cooling the heated surface 108 as shown. Cooling air can also exit through the third cooling passage to cool the fore edge 105 of the inner band 103.

It will be understood that other cooling passages can be provided to fluidly couple the cooling cavity 120 to other parts of the inner band 103.

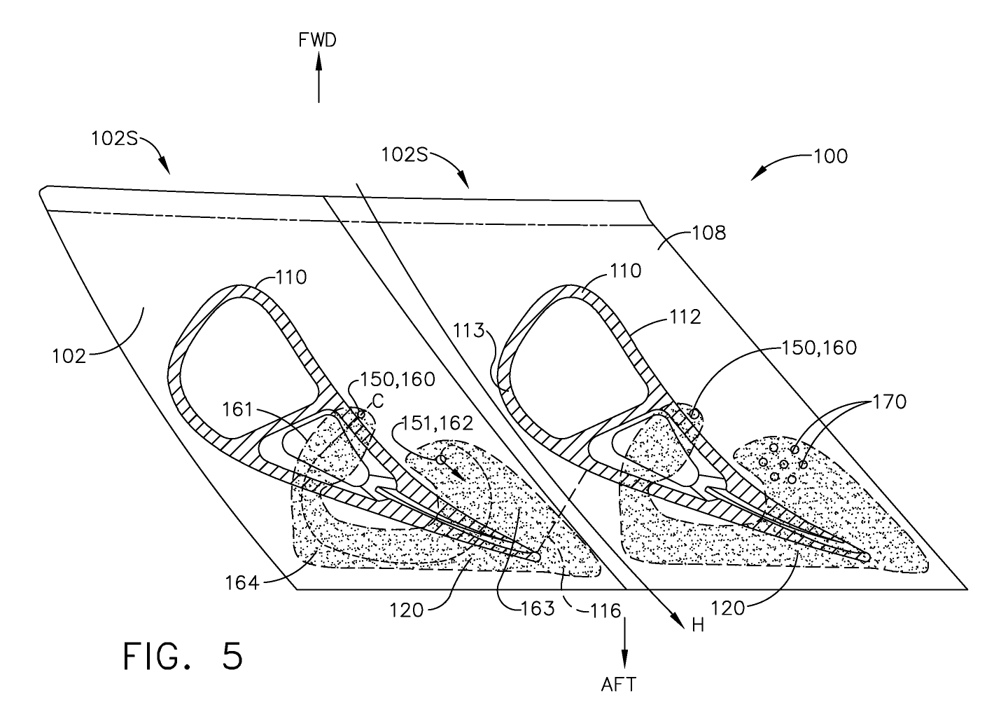

Referring now to FIG. 5, the airfoil assembly 100 is illustrated with two segments 102S each having an airfoil 110. A cooling cavity 120 is illustrated in each segment 102. The cooling cavity 120 can be formed with a general U-shape within the inner band 103. The inlet 150 can define a first end 160 to a first arm 161 of the cavity 120, and the outlet 151 can define a second end 162 to a second arm 163 of the cavity 120. A bight section 164 can connect the first and second arms 161, 163.

In a non-limiting example the first and second ends 160, 162 can be positioned adjacent the pressure side 112 of the airfoil 110 while the bight 164 is positioned adjacent the suction side 113. It is also contemplated in another example (not illustrated) that the ends 160, 162 can be positioned adjacent the suction side 113 while the bight 164 is positioned adjacent the pressure side 112.

In addition, the inlet 150 and outlet 151 can both be positioned upstream or forward of the throat 116 while the cooling cavity 120 extends downstream or aft of the throat 116. It will be understood that other positional arrangements for the cooling cavity 120, inlet 150, and outlet 151 are contemplated in the spirit of the present disclosure.

The cool gas flow C can move from the inlet 150 located on the cooled surface 109 to the cooling cavity 120 beneath the airfoil 110, through the bight 164, and forward to the outlet 151 before exiting to the heated surface 108. In another example the cool gas flow C can also be directed to the pressure side 112 of the airfoil 110. In addition, while a single outlet 151 is illustrated, it is also contemplated that an array of outlets 151 can be used, such as film holes 170, to direct the cool gas flow C along the heated surface 108.

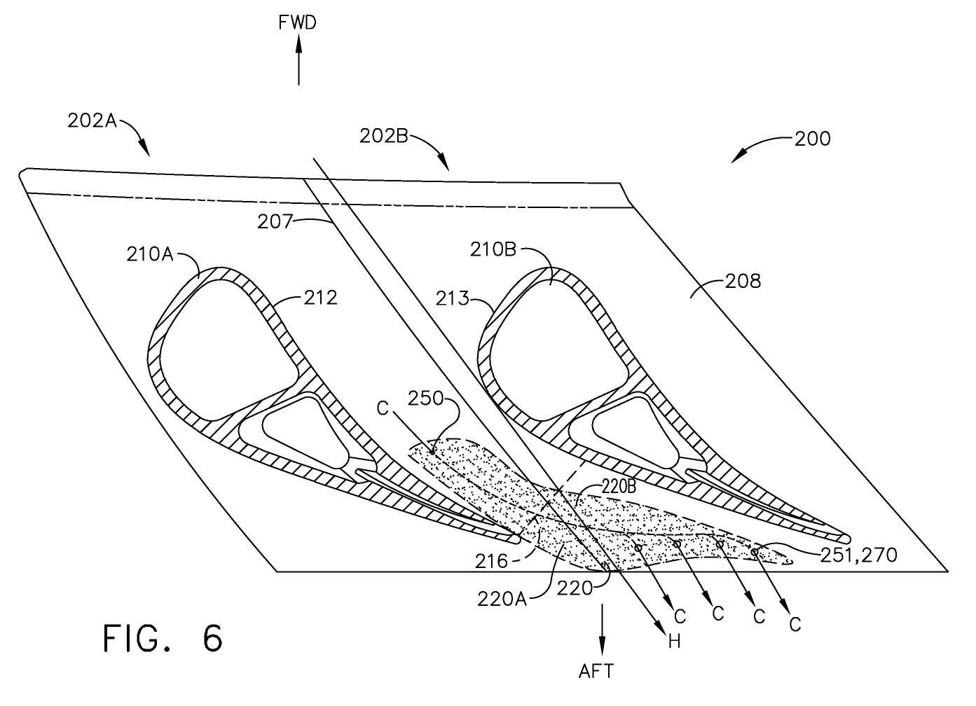

Turning to FIG. 6, another airfoil assembly 200 is illustrated which can be utilized in the turbine engine 10 of FIG. 1. The airfoil assembly 200 is similar to the airfoil assembly 100; therefore, like parts will be identified with like numerals increased by 100, with it being understood that the description of the like parts of the airfoil assembly 100 applies to the airfoil assembly 200, unless otherwise noted.

The airfoil assembly 200 is illustrated with a first segment 202A having a first airfoil 210A, as well as a second segment 202B having a second airfoil 210B. A cooling cavity 220 can extend across an interface 207 between the segments 202A, 202B. An inlet 250 can be positioned on the first segment 202A adjacent a pressure side 212 of the first airfoil 210A, and also positioned upstream or forward of a throat 216. An outlet 251 illustrated as film holes 270 can be positioned on a heated surface 208 of the second segment 202B, adjacent the suction side 213 of the second airfoil 210B, and also downstream or aft of the throat 216. In such a case, the cooling cavity 220 can be formed with a complementary geometry across the interface 207, such as a first cavity portion 220A and a second cavity portion 220B, such that the portions 220A, 220B form the completed cooling cavity 220 when the segments 202A, 202B are assembled.

The cool gas flow C can enter the inlet 250, flow through the cavity 220 across the interface 207, and exit through the outlet 251 or film holes 270. It is also contemplated that the outlet 251 can align the cool gas flow C with the hot gas flow H to cool the heated surface 208.

In an exemplary doublet example where the first and second airfoils 210A, 210B are formed on a single segment 202, it is contemplated that the inlet 250 and outlet 251 can be positioned as described in FIG. 6 where the cooling cavity 220 is formed as a single piece between the airfoils 210A, 210B.

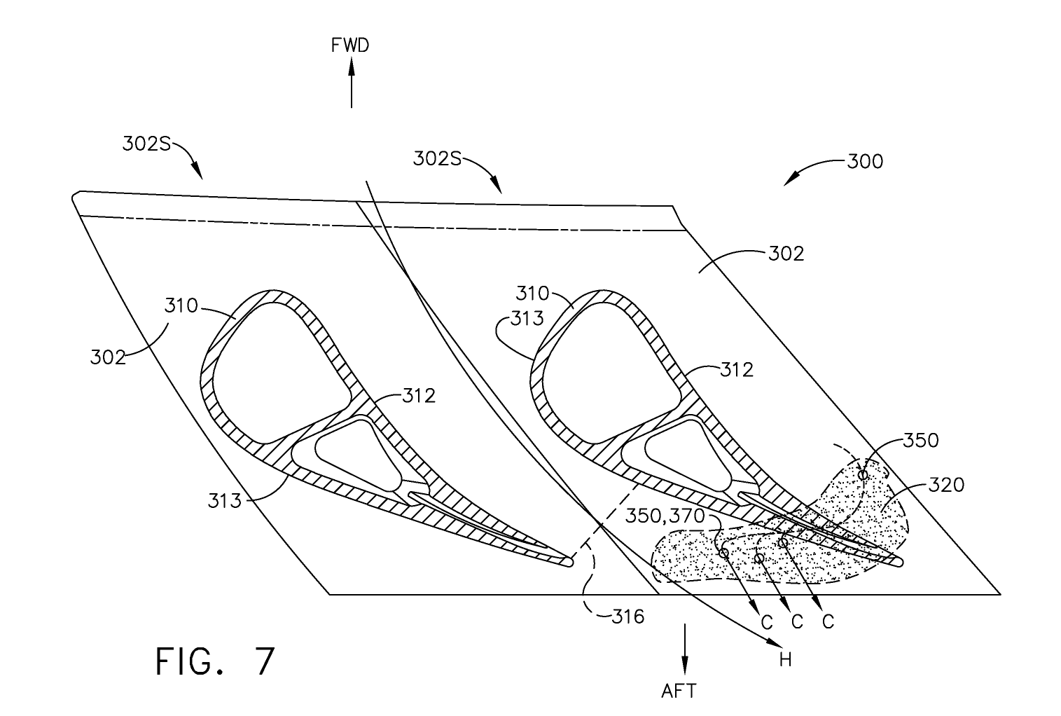

Referring now to FIG. 7, another airfoil assembly 300 is illustrated which can be utilized in the turbine engine 10 of FIG. 1. The airfoil assembly 300 is similar to the nozzle assemblies 100, 200; therefore, like parts will be identified with like numerals further increased by 100, with it being understood that the description of the like parts of the airfoil assembly 100 applies to the airfoil assembly 300, unless otherwise noted.

The airfoil assembly 300 is illustrated with two platform segments 302S each having an airfoil 310, the shortest distance between adjacent airfoils 310 defining a throat 316 as shown. A cooling cavity 320 in a segment 302S can be positioned aft of the throat 316. The cavity 320 can have an inlet 350 adjacent a pressure side 312 of the airfoil 310, as well as an outlet 351 in a heated surface 308, illustrated as a plurality of film holes 370, adjacent a suction side 313 of the airfoil 310. It is contemplated that the inlet 350 and outlet 351 can both be positioned downstream, or aft, of the throat 316 as shown. In operation, the cool gas flow C can enter the cavity 320 through the inlet 350 and exit through the outlet 351 or film holes 370.

A method of supplying cooling air to the cooling cavity 120 (FIG. 4) in the turbine engine 10 can include supplying cooling air such as the cool gas flow C along the first cooling passage 131 and emitting the cool gas flow C through the second cooling passage 132. The cool gas flow C can be supplied as an impingement flow onto the inner wall 121 of the cavity 120 as seen in the example of FIG. 4. In non-limiting examples, the cool gas flow C can be emitted via the third cooling passage 133 to the fore edge 105 as illustrated in FIG. 4, or emitted to the interface 107 which can include a splitline gap between the segments 202A, 202B in the example of FIG. 6, or emitted through the array of film holes 170 as seen in FIG. 7.

It can be appreciated that other arrangements of cooling cavities and cooling passages, while not illustrated, can nonetheless be utilized in the turbine engine of FIG. 1. Such arrangements can include, but are not limited to, the following examples, and it will be understood that aspects of the following examples can be utilized in any desired combination in the spirit of the present disclosure.

In one example, the cool gas flow through a nozzle such as that illustrated in FIG. 3 can enter the cooling cavity via a first cooling passage with an inlet positioned on the cooled surface forward of the flange. The cool gas flow can exit the cooling cavity via the second cooling passage positioned forward of the throat. It is also contemplated that at least a portion of the cooling cavity can extend aft of the throat.

In another example, the cool gas flow can enter the cooling cavity via a first cooling passage and exit the cooling cavity via a second cooling passage having an outlet directed toward an interior channel within the airfoil. The second cooling passage can also include an outlet directed toward the heated surface of the platform adjacent the pressure side or suction side of the airfoil. Furthermore, the second cooling passage can have multiple outlets such that cooling air can be supplied to multiple locations of the airfoil assembly as desired.

In still another example, the cooling cavity within the platform can be formed in a serpentine fashion, directing the cool gas flow to be emitted along the heated surface of the platform or to the interior of the airfoil. In one example where the cool gas flow exits the cooling cavity into the airfoil interior, it is contemplated that the flow can be emitted through the trailing edge of the airfoil. Furthermore, the cooling cavity can be fluidly coupled to the airfoil interior such that the cool gas flow can be directed through the platform, into the airfoil interior, and back into the platform before being emitted to the heated surface of the platform via film holes or other outlets.

In yet another example, the cool gas flow can exit the cooling cavity via at least one film hole which directs the cooling flow onto the airfoil exterior. In such a case, the cool gas flow can be directed onto the pressure side or suction side of the airfoil, or to any position on the airfoil exterior where cooling is desired.

Aspects of the present disclosure provide for a variety of benefits. It can be appreciated that use of the cooling cavity can increase cooling effectiveness on engine components experiencing high temperatures such as those encountered in the high pressure turbine or high pressure compressor. Improving the cooling on such components can improve part life and reduce operation costs. In addition, the use of additive manufacturing can provide for increased complexity of the cooling cavity and cooling passages, including positioning the cooling passages in locations that are traditionally difficult to perform line-of-sight drilling or other operations.

It should be understood that application of the disclosed design is not limited to turbine engines with fan and booster sections, but is applicable to turbojets and turboshaft engines as well.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An airfoil assembly for a turbine engine comprising:
a platform having a fore edge, an aft edge axially spaced from the fore edge, and opposing heated and cooled surfaces separating a hot gas flow along the heated surface from a cool gas flow along the cooled surface;
an airfoil extending from the heated surface of the platform, the airfoil having a leading edge and a trailing edge and extending between a pressure side and a suction side;
a cooling cavity located interiorly of the platform;
a first cooling passage fluidly connecting the cooled surface to the cooling cavity and defining a first centerline; and
a second cooling passage fluidly connecting the heated surface to the cooling cavity and defining a second centerline, which is unaligned with the first centerline.

2. The airfoil assembly of claim 1 further comprising a third cooling passage fluidly connecting the cooling cavity to the fore edge of the platform.

3. The airfoil assembly of claim 2 wherein the third cooling passage defines a third centerline, which is unaligned with both of the first and second centerlines.

4. The airfoil assembly of claim 1 further comprising at least two vanes circumferentially spaced from each other, with the intervening space defining a nozzle with a throat.

5. The airfoil assembly of claim 4 wherein the second centerline intersects the heated surface upstream of the throat relative to an airflow direction through the nozzle.

6. The airfoil assembly of claim 4 wherein the entire cooling cavity is positioned downstream of the throat relative to an airflow direction through the nozzle.

7. The airfoil assembly of claim 4 wherein the first cooling passage is positioned forward of the throat, the second cooling passage is positioned aft of the throat, and at least a portion of the cooling cavity is positioned aft of the throat.

8. The airfoil assembly of claim 4 wherein the first cooling passage is positioned forward of a flange in the platform, and the second cooling passage is positioned aft of the flange.

9. The airfoil assembly of claim 1 wherein the platform comprises circumferentially arranged segments in abutting relationship such that adjacent segments define an interface, and the cooling cavity extends across the interface.

10. The airfoil assembly of claim 9 further comprising at least two airfoils circumferentially spaced from each other with the intervening space defining a nozzle with a throat.

11. The airfoil assembly of claim 10 wherein the cooling cavity comprises a U-shaped cavity with a first arm having a first end, a second arm having a second end, and a bight extending across the interface and connecting the first arm with the second arm.

12. The airfoil assembly of claim 10 wherein the entire cooling cavity is positioned downstream of the throat relative to an airflow direction through the nozzle.

13. The airfoil assembly of claim 10 wherein the first cooling passage is positioned forward of the throat and the second cooling passage is positioned aft of the throat.

14. The airfoil assembly of claim 10 wherein both of the first and second cooling passages are positioned upstream of the throat, and the cooling cavity is positioned downstream of the throat relative to an airflow direction through the nozzle.

15. The airfoil assembly of claim 1 wherein the cooling cavity comprises a U-shaped cavity with a first arm having a first end, a second arm having a second end, and a bight connecting the first arm and the second arm.

16. The airfoil assembly of claim 15 wherein both of the first end and the second end are adjacent one of the pressure side or the suction side of the airfoil.

17. The airfoil assembly of claim 15 wherein the bight is adjacent the other of the pressure side or the suction side of the airfoil.

18. A turbine engine comprising a fan section, compressor section, a combustion section, and a turbine section in axial flow arrangement to define an engine centerline, with at least one of the compressor section and turbine section having an airfoil assembly comprising:
radially spaced inner and outer bands having axially spaced fore and aft edges, with at least one of the inner and outer bands having opposing heated and cooled surfaces separating a hot gas flow from a cool gas flow;
at least two airfoils extending between the inner and outer bands; each of the at least two airfoils having a leading edge and a trailing edge and extending between a pressure side and a suction side;
a cooling cavity located interiorly of the at least one of the inner or outer bands;
a first cooling passage fluidly connecting the cooled surface to the cooling cavity and defining a first centerline; and
a second cooling passage fluidly connecting the heated surface to the cooling cavity and defining a second centerline, which is unaligned with the first centerline.

19. The turbine engine of claim 18 further comprising a third cooling passage fluidly connecting the cooling cavity to the fore edge of the at least one of the inner and outer bands.

20. The turbine engine of claim 19 wherein the third cooling passage defines a third centerline, which is unaligned with both of the first and second centerlines.

21. The turbine engine of claim 18 wherein the at least two airfoils are circumferentially spaced from each other with the intervening space defining a nozzle with a throat.

22. The turbine engine of claim 21 wherein the second centerline intersects the heated surface upstream of the throat relative to an airflow direction through the nozzle.

23. The turbine engine of claim 21 wherein the entire cooling cavity is positioned downstream of the throat relative to an airflow direction through the nozzle.

24. The turbine engine of claim 21 wherein the first cooling passage is positioned forward of the throat and the second cooling passage is positioned aft of the throat.

25. The turbine engine of claim 18 wherein the at least one of the inner and outer bands comprises circumferentially arranged segments in abutting relationship such that adjacent segments define an interface, and the cooling cavity extends across the interface.

26. The turbine engine of claim 18 wherein the cooling cavity comprises a U-shaped cavity with a first arm having a first end, a second arm having a second end, and a bight connecting the first arm and the second arm.

27. A method of supplying cooling air to a cavity in a cooled platform in a turbine engine, the method comprising:
supplying cooling air from a cooled surface of the platform along a first direction through a first passage; and
emitting the cooling air to a heated surface of the platform along a second direction through a second passage, the second direction being different from the first direction.

28. The method of claim 27 wherein the supplying further comprises supplying cooling air as an impingement flow onto an interior wall of the cavity.

29. The method of claim 27 wherein the emitting further comprises emitting the cooling air to a splitline gap.

30. The method of claim 27 further comprising flowing the cooling air through an array of film hole outlets.
